(19) United States
(12) Patent Application Publication
(10) Pub. No.: US 2012/0181238 A1
(43) Pub. Date: Jul. 19, 2012

(54) WATER TREATMENT SYSTEM

(75) Inventors: Arthur SUSSMAN, Cliffside Park, NJ (US); Lora Sussman, Cliffside Park, NJ (US)

(73) Assignee: PRISTINA CAPITAL PARTNERS, LLC, Midland Park, NJ (US)

(21) Appl. No.: 13/234,940

(22) Filed: Sep. 16, 2011

Related U.S. Application Data
(63) Continuation-in-part of application No. PCT/US2010/027807, filed on Mar. 18, 2010.
(60) Provisional application No. 61/161,230, filed on Mar. 18, 2009.

(51) Int. Cl. C02F 1/00; B01D 29/92; B01D 29/62; B01D 37/04; B01D 37/00

(52) U.S. Cl. 210/790; 210/257.1; 210/97; 210/116; 210/128

(57) ABSTRACT

A water treatment system can be essentially non-electric, and can use gravity to produce water that is safe for drinking. By such a system there can be provided a low cost, reliable way to treat water that is contaminated by water borne pathogens, to reduce or eliminate such contaminants to a safe level, and thereby produce water that is drinkable.

### CROSS REFERENCE TO RELATED APPLICATIONS

This application is related to and claims the priority of U.S. Provisional Patent Application No. 61/161,230 (the '230 application), filed on Mar. 18, 2009, and WO Application PCT/US2010/027807 (the '807 application), filed Mar. 18, 2010, the contents of which are hereby incorporated herein fully by reference. The present application is a Continuation-In-Part application of the '807 application, which in turn claims the priority of the '230 application.

### BACKGROUND

1. Field

More than one billion people, one sixth of the world's population, currently lack access to a safe potable water supply. At any given moment half the world's poor are suffering from water borne diseases caused by water contaminated by protozoa parasites, bacteria, and viruses. Over six thousand people, primarily children, die each day by consuming unsafe drinking water. A system according to certain embodiments of the present invention addresses this problem, as well as other potable water issues including production of drinking water for emergency, service, and recreational use. It can provide an affordable, effective means for reducing or eliminating such pathogens from available water supplies. Thus, it can produce potable water for regions of the world where potable water is in very short supply, and where there is a shortage of capital and infrastructure to produce potable water by conventional means.

2. Description of the Related Art

Water contamination in the form of water borne pathogens are long-standing concern well known to science. Biologists and microbiologists are well aware of such pathogen behaviors and the hazards to humans. Methods of disinfecting water are also well known. For the purpose of producing potable water, most methods of treatment are designed to treat very large bodies of water to serve large populations. Most conventional systems make use of large equipment such as electric pumps, motors, filtration systems, and instrumentation to assure that the large volumes of water being delivered are disinfected safely for human consumption. Chlorination systems typically make use of disinfection properties of chlorine, in the form of sodium hypochlorite, to interact with pathogens and destroy them in the process. Ozonation systems are also used either as a supplement to chlorination systems, or for smaller centralized populations. Ozone is a strong oxidizer possessing excellent disinfection properties, but vaporizes too rapidly to produce long term effective water sanitizing. Reverse osmosis is another method used to produce drinkable water, it uses filtration not only to disinfect water, but also as a means of desalinating sea water.

Ultraviolet (UV) irradiated systems and tablet dispensers are also available. These systems produce low volumes of water, produce inconsistent disinfection results, and require electricity to operate. In many regions, electricity is not available.

Larger conventional water treatment methods are used to produce potable water for industrialized regions of the world. Such methods are less effective in the less-developed regions of the Third World, and for other applications where low cost, reliable water disinfection is required. They can cost from hundreds of thousands of dollars to many millions of dollars. They can require extensive infrastructure including electricity, water pumping stations, rail lines and roadways to support operations, and technical staff to design build and operate equipment. Water shortage problems encountered in the Third World are special problems. The problems affect hundreds of millions of people in regions of the world where neither the capital, infrastructure, electricity (in many cases), nor the technical skills to solve the water shortage problems by conventional means.

A number of pathogens can exist in contaminated water. The most pervasive of the pathogens are protozoa, which are cystic parasites that attack the digestive system, and (in some cases) the central nervous system. They range in size from approx 1.0-15.0 microns. They are tiny in size compared to a human being, but are relatively large compared to other toxic organisms. Certain strains like cryptosporidium parvum and giardia lamblia are among the most aggressive of the protozoa, and cause severe diarrhea, fever, and other serious intestinal sickness, and which are often fatal. Bacteria are typically single celled organisms that are slightly smaller in size than protozoa ranging in size from approx 0.25-1.0 microns, of which klebsiella, Escherichia coli (E. coli), and salmonella strains are the most aggressive, and which cause severe intestinal infections, and diarrhea particularly hazardous to children.

Viruses, the third class of pathogens are the smallest known agents of disease, of which hepatitis, rotavirus, and polio are well known, ranging in size from 20-30 nanometers, where the infection comes as a result of embedding in normally healthy “host” cells that become infected by the virus, and which are very toxic to humans. The invention here, in its preferred embodiment, again makes use of nonelectric means, and operates as a 3 stage process to treat contaminated water, and where pathogens listed above, are either removed, or reduced to a safe level to produce water that is safe for drinking.

### SUMMARY

According to certain embodiments, the present invention can be an apparatus. The apparatus can include first fluid input means for receiving first fluid having contamination therein disposed rendering the first fluid un-potable. The apparatus can also include first conveyance means for inducing first fluid flow from the first fluid input means through the first conveyance means. In an alternative embodiment, the first conveyance means may be separate from an inducing means that induces fluid flow, which transmits fluid from the first input means through the first conveyance means.

Attachment means for attaching the first conveyance means to the first fluid input means can be included in the apparatus. Second conveyance means for conveying the first fluid to filtering means for rendering the first fluid as a first filtered fluid can also be included in the apparatus. The apparatus can further include third conveyance means for conveying the first filtered fluid to a first container. First inducing means for inducing a second filtered fluid flow along fourth conveyance means for conveying the second filtered fluid from the first container can further be included in the apparatus. The apparatus can additionally include dividing means for dividing the second filtered fluid flow into a third filtered fluid flow and a fourth filtered fluid flow. Another feature of the apparatus can be fourth conveyance means for conveying the third filtered fluid flow to activate a second fluid input means, wherein the second fluid input means comprises dispensing means. Likewise, a feature of the apparatus can also be fifth conveyance means for conveying the second filtered fluid flow to a second container. The apparatus can also include sixth conveyance means for conveying second fluid from dispensing means. The apparatus can further include combining means for combining the second fluid with the second filtered fluid to provide a combined fluid. Seventh conveyance means for conveying the combined fluid to flow into second container can be included in the apparatus, as can second inducing means for inducing flow of combined fluid contained in the second container. The apparatus can further include eighth conveying means for conveying flow of combined fluid contained in the second container to an output port with a valve attached thereto. The valve can be configured to provide output flow for the combined fluid and the combined fluid can be potable.

According to certain embodiments, the present invention can be an apparatus. The apparatus can include a first fluid input configured to receive first fluid. The apparatus can also include a first conveyance configured to induce first fluid flow from the first fluid input through the first conveyance. The apparatus can further include a connector configured to attach the first conveyance to the first fluid input. A second conveyance configured to convey the first fluid to a filter, the filter configured to render the first fluid as a first filtered fluid can also be included in the apparatus. A third conveyance configured to convey the first filtered fluid to a first container can further be included in the apparatus. A first fluid driver configured to induce a second filtered fluid flow along fourth conveyance configured to convey the second filtered fluid from the first container can additionally be included in the apparatus, as can a splitter configured to divide the second filtered fluid flow into a third filtered fluid flow and a fourth filtered fluid flow. The apparatus can also include a fourth conveyance configured to convey the third filtered fluid flow to activate a second fluid input, wherein the second fluid input comprises a dispenser. The apparatus can further include a fifth conveyance configured to convey the second filtered fluid flow to a second container. A sixth conveyance configured to convey second fluid from the dispenser and a combiner configured to combine the second fluid with the second filtered fluid to provide a combined fluid can be included in the apparatus. The apparatus can additionally include a seventh conveyance configured to convey the combined fluid to flow into a second container. The apparatus can also include a second fluid driver configured to induce flow of combined fluid contained in the second container and an eighth conveyance configured to convey flow of combined fluid contained in the second container to an output port with a valve attached thereto. The valve can be configured to provide output flow for the combined fluid and the combined fluid is potable.

In certain embodiments, the present invention is a method. The method can include providing, at a first fluid input, first fluid. The method can also include inducing first fluid flow from the first fluid input through a first conveyance, a connector attaching the first conveyance to the first fluid input, and a second conveyance that conveys the first fluid to a filter. The method can further include rendering the first fluid as a first filtered fluid by the filter. Conveying the first filtered fluid to a first container and inducing a second filtered fluid flow along a third conveyance that conveys the second filtered fluid from the first container can also be included in the method. Additionally, dividing the second filtered fluid flow into a third filtered fluid flow and a fourth filtered fluid flow can be included in the method. The method can also include conveying the third filtered fluid flow to activate a second fluid input, wherein the second fluid input comprises a dispenser and subsequently to a second container. The method can further include conveying second fluid from the dispenser in response to being activated by the third filtered fluid flow and combining the second fluid with the second filtered fluid to provide a combined fluid. Conveying the combined fluid to flow into the second container can further be included in the method, as can inducing flow of combined fluid contained in the second container to an output port with a valve attached thereto. The valve can be configured to provide output flow for the combined fluid and the combined fluid can be potable.

### BRIEF DESCRIPTION OF THE DRAWINGS

For proper understanding of the invention, reference should be made to the accompanying drawings, wherein:

FIG. 1 illustrates an apparatus or water system according to an embodiment of the present invention.

FIG. 2 illustrates a pump and counter mechanism according to certain embodiments of the present invention.

FIG. 3 illustrates a method according to certain embodiments of the present invention.

### DETAILED DESCRIPTION

Certain embodiments of the present invention are designed to provide drinkable water for small groups and villages of people, and for similar applications including emergency circumstances, and field service operations. Such embodiments may be able to provide high quality water at very low cost, reliably for people suffering from the effects of contaminated water.

Certain embodiments of the present invention provide a system that is a uniquely simple, reliable, low-cost means of producing potable water. Though the system may be principally for use by poor regions of the world, other valuable uses are anticipated including, but not limited to responses to weather and similar types of emergencies, spot water shortages, outdoor recreational activities, as well as for service type applications including military, homeland security, forest preservation, and special residential needs. It can be essentially non-electric, can make use of gravity to sanitize water, can be simple to install and operate, and can be readily installed to substantially meet community drinking water needs in most places, worldwide.

The system according to certain embodiments of the present invention disinfects water in 3 stages. Stage 1, a first filtration stage, filters incoming contaminated water of particulate that the water may contain, and larger microorganisms that could be harmful if consumed. Examples of larger microorganisms include protozoa organisms such as cryptosporidium and giardia. Stage 2 is a mixing stage which prepares the disinfection solution in precise proportions and is used for the bacteria and virus disinfection. Stage 3 provides oxidation reduction reactions in water and provides sanitizer contact time required to reduce or eliminate bacteria and viruses.

Contact times, in stage 3, can be a function of water flow rates of the system, sanitizer dilutions of the water, as determined, for example, by experimental data published in Environmental Protection Agency (EPA) and World Health Organization (WHO) documents which list (based on experimentation) contact times recommended for each organism are based or type of disinfectant used, organism of interest, and dilution of disinfectant solution in terms of mg per liter, or parts per million of disinfectant used. Contact times can be determined by the volume capacity of the tanks being used. Organisms targeted for reduction or elimination can include klebsiella, E. coli, and salmonella bacteria as well as hepatitis, rotovirus, MS2, and Fr coliphages. Dilutions for potable use, flow rates of the water being processed, and log reductions required to make water potable can be derived from WHO and EPA documents. Contact times of approximately ten minutes can, for example, be incorporated into the design of the contact tanks.

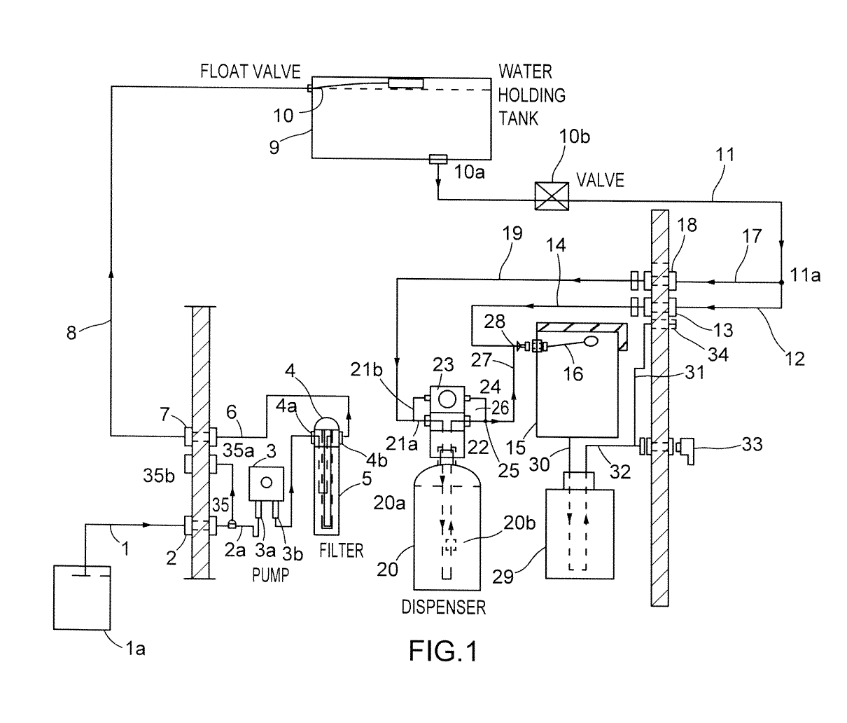

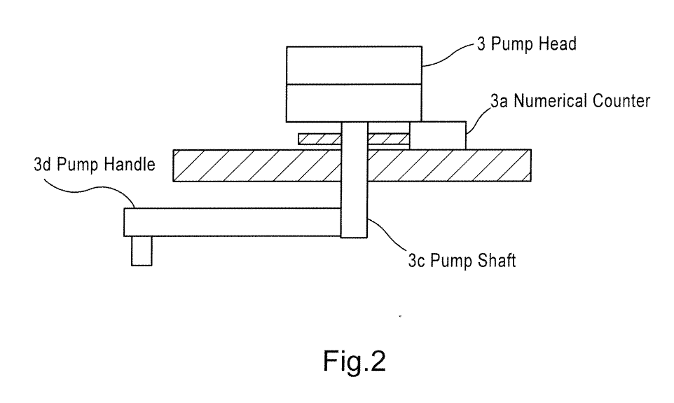

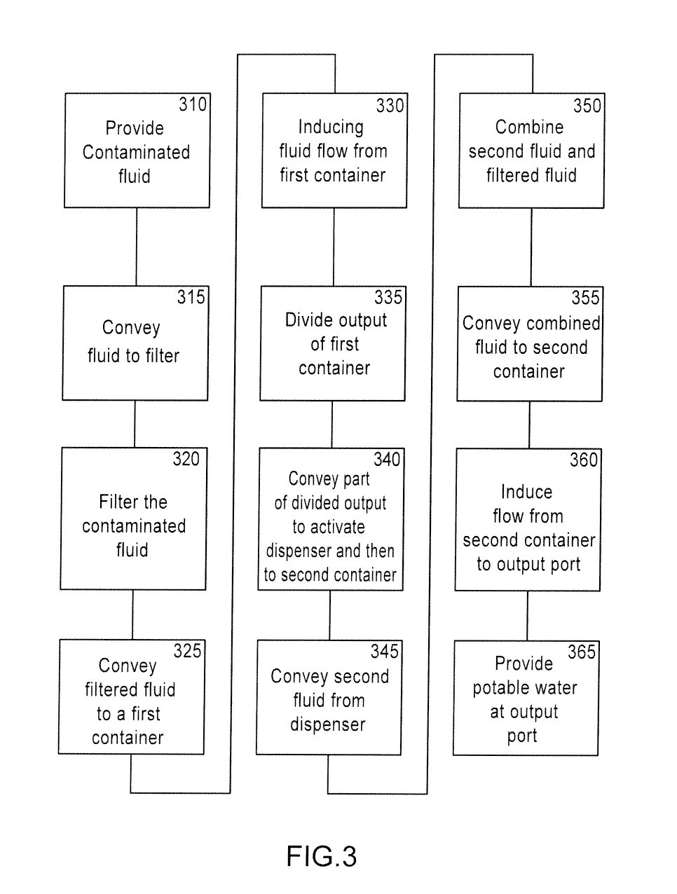

Though certain embodiments of the present invention do not require a power source, such as electricity, in other embodiments of the invention, where electricity sources are available, motorized pumping means, electric solenoid valves, and electrically activated water level sensing means can be used for automation of various aspects, including, for example, stages 1, 2, and 3 of certain embodiments the invention. Description of embodiments of the invention as follows makes use of FIGS. 1 and 2 in which components of the invention are referenced. FIGS. 3-5 are not referenced in the description and are provided as magnified images to assist in viewing components and flow processes described.

### Stage 1

Stage 1, as shown in the embodiment of FIG. 1, can deal with protozoan organisms including cryptosporidium and giardia strains of protozoa. These are large cystic parasites, having a size range of between 1.0 and 15 microns, and are reduced or eliminated using a microfiltration process, as shown in FIG. 1. As shown, contaminated water 1a that may contain any or all of the contaminants described above, and that may have been pre-filtered by a sediment filter or similar means, may be contained in an outer tank, or drawn directly from a well or river. Pump 3 induces water flow along tubing 1, and thereafter to the filter assembly 4.

The pump, which may be a manual tubing type pump, commonly referred to as a peristaltic type pump, as partially shown in FIG. 2, can include a pump enclosure which houses a pinch rotor assembly, flexible tubing, a drive shaft connected to the pinch rotor assembly, and a pump handle. The flexible tubing can be installed along the curved periphery molded into the inside of the pump housing, and can occupy a pinch disposition as it is contained between rollers of the rotor assembly, and the curved platen. When the pump is activated, for example, by manual rotation of the pump handle 3d, for example in the clockwise direction as shown, the pinch rotor presses the flexible tubing against a curved platen molded into the pump housing. The ends of the tubing extend below the pump housing where tubing 2a can be connected to flexible tubing at 3a. The rotary action of the pump rotor produces negative pressure, and thereby a suction at the tubing end 3a, and creates positive pressure at tubing end 3b. Water flow that is induced along tubing 1, as shown in FIG. 1, thereafter flows through connector 2 attached to exterior of the main console of the invention, then sequentially through the pump tubing through 3a and 3b and then to the input connection 4a of the filter assembly 4. Use of quick connector 2 at console ports simplifies system installation without the need for special tools.

An alternative pump may be used. The alternative pump may be a diaphragm pump, such as a diaphragm lever pump, for example, the Gasboy Model 1720A-UL diaphragm lever pump, available from Gilbarco Inc., of Greensboro, N.C.

In certain embodiments, the filter for this system contains a ceramic like cartridge 5. Under pressure, induced by the water pump, water can be forced through 4a, and through the cartridge assembly 5, where filtration occurs, and then out through connector 4b of filter 4. The cartridge 5 can, for example, have a ceramic type structure, allowing easy maintenance, and re-use, and contains micro bores along its surface and within its thickness. Water that flows into filter housing 4 thereafter flows radially, and inward through the cartridge 5, and exits the filter at connector 4b. The filter assembly with the cartridge installed contains micro-bores that are capable of filtering physical matter 1.0 microns in size and larger, typically cryptosporidium and giardia organisms, as well as similar sized particulate that may be present.

An alternative filter may be used. The alternative filter may be an ultrafiltration membrane, such as a hollow fiber, filter, for example, an Ultra-flo BT 420 cartridge filter available from Mann+Hummel of Singapore.

Water exiting 4b, will be filtered water, which under water pressure induced by the pump 3, flows along tubing 6, where it exits the main console of the invention through connector 7. The filtered water thereafter flows along tubing 8 attached by a connector to the water holding tank 9, and which can be installed for example above the main console. The height of the tank above the main console provides the head pressure necessary for the activation of stages 2 and 3 of the disinfection process. Filtered water flowing through tubing 8 flows into holding tank 9 through float valve means 10 therein attached, and in close proximity to the top surface of the holding tank where the filtered water accumulates. Valve 10b can be, for example, attached at the base of the tank 10a, which provides a selective holding tank drain feature, when disposed in closed position permits filtered water flowing from tubing 8 to accumulate within the holding tank to the height of the float valve, which activation interrupts filtered water flow such that holding tank is said to be filled. This completes stage 1 wherein cystic parasites have been eliminated or reduced from the water as required, and which provides head pressure for processing water through stages 2 and 3.

Further to description of stage 1, a tubing pump 3 is preferred over other pump types such as vain type and diaphragm type pumps for this application, in which flow volumes are relatively small. Tubing pumps can be used bi-directionally and can permit filtering water when operated in forward direction, while also permitting backwash of the filter when operated in a reverse direction. Tubing pumps can be self priming, contain no seals, work well with slurries, and have good lift abilities, capable of drawing in water from long distances that may be required in certain embodiments. Tubing pumps typically require few parts, making them inexpensive to service and very reliable, and they can be a reversible. A reversible pump can be used to provide a filter backwash feature, which reduces filter maintenance and cost.

For filtration, a ceramic-type filter can be used. Such filters may be more cost effective than paper type filters, which require frequent maintenance and replacement. In certain embodiments, the filter can be reusable, requiring infrequent cleaning, and can operate for longer periods of time, such as a year, before replacement is needed.

### Stage 2

The process of stage 2 can produce a combination of filtered water, which may contain bacterial and viral contaminants, and liquid sanitizer dispensed into the water in precise proportions. The combination produced in stage 2 can be used during stage 3 process, which can be a final sanitizing stage. Accordingly, the stage 2 process can be activated by disposing valve 10b to the open position. When valve 10b disposed is opened, filtered water that has accumulated in the holding tank during stage 1 process flows by means of the force of gravity or other flow inducing means such as a mechanically applied pressure, out of the tank through valve 10b, either interposed within tubing 11, or attached to holding take at 10a, and thereafter flows along tubing 11, and thereafter to tubing junction 11a, with fitting means interposed, and which thereafter divides into two tubing paths, 12, and 17.

Tubing path 12, having, for example, a larger diameter of the two tubing paths contains main filtered water flow. Tubing path 17, having, for example, a diameter smaller than tubing 12, activates sanitizer dispensing means. Tubing path 12, with water flow, and pressure, induced for example by gravity, flows through connector 13, attached to main console of invention, and thereafter along tubing 14, and into container 15 through float valve 16 attached thereto.

Water flowing through tubing 17, having diameter smaller than tubing 12, flows through connector 18, and thereafter along tubing 19, which can attach to a fitting interposed therein, which can connect to dispenser 20 by means of tubing 21a, and 21b, and thereby activate dispenser 20. Dispenser can be constructed, for example, according to U.S. Pat. No. 6,123,839 (the '839 patent), which is hereby incorporated herein by reference in its entirety. Dispenser activation, as described in the '839 patent, and also, for example, by gravity means, can induce flow of liquid sanitizer, liquid chlorine, in certain embodiments, within tubing 25 as regulated sanitizer flow, which can combine with the main water flow. After this combination, the water can be referred to as combined water. The combined water can have a precise sanitizer dilution.

Accordingly, liquid sanitizer flow induced along tubing 25 can intersect with the main water flowing along tubing 14 by means of fitting 28 therein interposed. This confluence can produce combined water flow having precise dilution. Use of gravity can be important to certain embodiments of the present invention. Gravity, as described in certain embodiments of this invention, provides a non-electric means of producing combined water having precise dilution, which will not change as a result of change in the flow inducing means for sanitizer, and main water. With such a system, the necessary precise dilution can be preserved irrespective of changes in the pressure that induces main water flow and changes in the pressure which activates the dispensing means. Gravity can be the force that induces both the main water flow, activation of the dispenser assembly, and regulation of the dispenser valve.

The force of gravity can be very precise, and the force of gravity typically remains essentially constant. As both the sanitizer flow and water flow are induced by the force of gravity and can be of an identical head, any change in head pressure can produce the same percentage of variation of water flow and sanitizer, and as a result, variations in water head will not produce a variation in the sanitizer dilution. Harnessing gravity properly can, therefore, eliminate the need for an external power source such as electricity to operate the system, which can be helpful for locations where electricity is not available. Gravity provides very precise regulation, and extremely accurate control of critical sanitizer dilutions without need for expensive mechanical and electronic components if regulation is provided by instrumental means. At completion of stage 2 operation of certain embodiments of the invention, combined water that results is of sufficient sanitizer dilution that it eliminates or reduces, by way of a stage 3 process, bacteria and viruses that may have been therein contained, as required to produce water that is drinkable.

### Stage 3

Combined water flowing into container 15 can flow at a velocity rate determined by gravity, and the head pressure impressed upon the combined water. The volume of combined water flow can be determined by the velocity, and diameter of tubing 14, and tubing 27, as intersected at fitting 28. As induced flow produced by same gravity source, flow velocity in tubing 14 can be equal to flow velocity of tubing 27, and accordingly dilution in terms of mg/liter of combined water can be determined by fixed ratio of sanitizer flow to main water flow.

Dilution of combined water as regulated by the dispensing means, with respect to flow rate of the main water can be arranged to be in the chlorination range of 1.0-5.0 mg/liter, which provides disinfection of the combined water, and which may be significant to the effectiveness of certain embodiments of the present invention. Combined water, having said dilution, and that flows into container 15 flows into container 29 by way of gravity, and by means of interconnecting tubing 30. Tubing 32 provides second flow means for combined water accumulated in container 29 to flow, by means of gravity, to on-off valve 33 attached to main console of invention.

Valve 33, when disposed to an off position, can allow combined water to accumulate in container 29, and by means of backflow thereafter accumulate in container 15, such that when a pre-set level reached, float 16 activates and interrupts water flow into container 15. The period of time duration for combined water to flow into container 15, thereafter into container 29 by way of tubing 30, to backflow into container 15, and to activate flow valve 16 thereby interrupting combined water flow can provides contact time for the combined water to eliminate or reduce bacteria and virus contamination to a point at which the combined water is safe for drinking. Tubing 31, attached to tubing 32, with the use of a fitting therein interposed can provide venting means for combined fluid. The fitting can prevent accumulation of air from interfering with combined water flow along tubing 32.

When valve 33 disposed in closed position, no water outflow occurs, and disinfected water stored in containers 29 and 15, which (when again disposed as open water outflow from valve 33) can serve as water that is disinfected and consequently drinkable. When valve 33 disposed in a closed position, no water outflow occurs, and disinfected water can be stored in containers 29 and 15. When valve 33 is again disposed as open, water outflow from valve 33 can be disinfected water that is drinkable. Tubing 31 attached to tubing 32 provides air venting means, and thereby prevents air pockets from forming within the tubing, as water flows along tubing 32, thereby preventing interference with water flow to valve 33.

### Backwash

Backwash can be performed to extend filter cartridge life and to reduce filter maintenance. By periodically backwashing the filter assembly, less maintenance may be needed to maximize water processing volume. Three-way valve 35 can be attached to tubing 2a, and therein interposed. Tubing 35a can provide selective means for operating pump 3 in a reverse direction for filter backwash. When pump rotation direction is reversed (for example, in a counter clockwise direction), water flow through filter 4 can be induced in a reverse direction. When valve 35 disposed for backwash operation, water flow along tubing 35a, and out through purge connector 35b, can be enabled.

Water flow along tubing 2a in a reverse direction can be disabled. The water reversal through the filter dislodges filtered matter accumulated in cartridge 5, and induces water containing dislodged matter to flow in a reverse direction. The water can flow thereafter through tubing 35a, and thereafter through purge connector 35b attached to main console. The flow containing filtered matter can be discarded to a purge tank or to a drain. Backwash can prevent unwanted particulate buildup within filter cartridge 5 from interfering with normal water flow, can minimize filter maintenance, and can extend the life of a cartridge prior to requiring replacement. For regular operation of the invention, the three-way valve can be selectively disposed to a position that allows normal operation of the system and in which water flow through connector 2 can be enabled, and water flow along tubing 35 can be disabled.

### Dispenser Fill Replacement

Referring to FIG. 2, numerical counter 3a (for example, mechanical with digital indication means) can be attached to pump 3 and can provide means for measuring number of pump rotations, and thereby the quantity of water processed corresponding to the rotations. Drive shaft 3c of pump 3 extends through opening in housing of main console, and thereupon attached can be pump handle 3d, which provides means for operation of pump 3 by manual means. Electric motor attached to main console and with motor drive mechanism attached to pump shaft 3c provides means for operation of pump using electric means. Numerical counter, for example mechanical, and attached to shaft 3c using mechanical means indicates numerically for each rotation of the pump, and thereby the accumulated within a given period.

For each rotation of the pump, a known quantity of water flows through the pump. Accordingly, such accumulated count can provide a means of measuring the amount of water processed within a period of time, and the amount of sanitizer that has been dispensed from the dispenser during the same period. Dispenser refills may be required at the end of each service cycle. The counter can be, for example, re-settable, so that when the counter indicates that a dispenser refill is required, and the dispenser has been refilled, the counter can be reset to again monitor sanitizer consumption, and again to indicate when a refill is needed. Electronic counters that are automatically resettable can be employed when refill automation is used.

FIG. 3 illustrates a method according to certain embodiments of the present invention. The method of FIG. 3 includes providing 310, at a first fluid input, first fluid having contamination therein disposed rendering the first fluid un-potable. In this embodiment, the method also includes inducing 315 first fluid flow from the first fluid input through a first conveyance, a connector attaching the first conveyance to the first fluid input, and a second conveyance that conveys the first fluid to a filter. The method as illustrated further includes rendering 320 the first fluid as a first filtered fluid by the filter.

The method of FIG. 3 also includes conveying 325 the first filtered fluid to a first container and inducing 330a second filtered fluid flow along a third conveyance that conveys the second filtered fluid outward from the first container. The method further includes dividing 335 the second filtered fluid flow into a third filtered fluid flow and a fourth filtered fluid flow. The method, in this embodiment, additionally includes conveying 340 the third filtered fluid flow to activate a second fluid input, wherein the second fluid input comprises a dispenser and subsequently to a second container.

In the embodiment illustrated in FIG. 3, the method further includes conveying 345 second fluid from the dispenser in response to being activated by the third filtered fluid flow and combining 350 the second fluid with the second filtered fluid to provide a combined fluid. The method also includes conveying 355 the combined fluid to flow into the second container and inducing 360 flow of combined fluid contained in the second container to an output port with a valve attached thereto. The valve can be configured to provide 365 output flow for the combined fluid and the combined fluid can be potable.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. For example, different pumps, filters, valves, tubing, and the like may be used, as the specific pumps, valves, tubing, and the like are merely examples. In order to determine the metes and bounds of the invention, therefore, reference should be made to the appended claims.

We claim:

1. An apparatus, comprising:
first fluid input means for receiving first fluid having contamination therein disposed rendering the first fluid un-potable;
first conveyance means for inducing first fluid flow from the first fluid input means through the first conveyance means;
attachment means for attaching the first conveyance means to the first fluid input means;
second conveyance means for conveying the first fluid to filtering means for rendering the first fluid as a first filtered fluid;
third conveyance means for conveying the first filtered fluid to a first container;
first inducing means for inducing a second filtered fluid flow along fourth conveyance means for conveying the second filtered fluid from the first container;
dividing means for dividing the second filtered fluid flow into a third filtered fluid flow and a fourth filtered fluid flow;
fourth conveyance means for conveying the third filtered fluid flow to activate a second fluid input means, wherein the second fluid input means comprises dispensing means;
fifth conveyance means for conveying the second filtered fluid flow to a second container;
sixth conveyance means for conveying second fluid from dispensing means;
combining means for combining the second fluid with the second filtered fluid to provide a combined fluid;
seventh conveyance means for conveying the combined fluid to flow into second container;
second inducing means for inducing flow of combined fluid contained in the second container; and
eighth conveying means for conveying flow of combined fluid contained in the second container to an output port with a valve attached thereto, wherein the valve is configured to provide output flow for the combined fluid, wherein the combined fluid is potable.

2. An apparatus, comprising:
a first fluid input configured to receive first fluid;
a first conveyance configured to induce first fluid flow from the first fluid input through the first conveyance;
a connector configured to attach the first conveyance to the first fluid input;
a second conveyance configured to convey the first fluid to a filter, said filter configured to render the first fluid as a first filtered fluid;
a third conveyance configured to convey the first filtered fluid to a first container;
a first fluid driver configured to induce a second filtered fluid flow along fourth conveyance configured to convey the second filtered fluid from the first container;
a splitter configured to divide the second filtered fluid flow into a third filtered fluid flow and a fourth filtered fluid flow;
a fourth conveyance configured to convey the third filtered fluid flow to activate a second fluid input, wherein the second fluid input comprises a dispenser;
a fifth conveyance configured to convey the second filtered fluid flow to a second container;
a sixth conveyance configured to convey second fluid from the dispenser;
a combiner configured to combine the second fluid with the second filtered fluid to provide a combined fluid;
a seventh conveyance configured to convey the combined fluid to flow into a second container;
a second fluid driver configured to induce flow of combined fluid contained in the second container; and
an eighth conveyance configured to convey flow of combined fluid contained in the second container to an output port with a valve attached thereto, wherein the valve is configured to provide output flow for the combined fluid, wherein the combined fluid is potable.

3. The apparatus of claim 2, wherein the first fluid comprises contaminated water.

4. The apparatus of claim 2, wherein the first fluid comprises contaminants including at least one of cystic organisms, bacteria, and viruses, which render the fluid unpotable.

5. The apparatus of claim 2, wherein the first conveyance comprises a pump configured to induce fluid flow selectively in forward and reverse directions.

6. The apparatus of claim 5, wherein the pump is manually activated.

7. The apparatus of claim 5, wherein the pump is electrically activated.

8. The apparatus of claim 2, wherein the filter comprises a housing with a connector configured to attach to the first fluid flow, and further comprises a displaceable cartridge-type filter component that is removable, and that can be maintained and reused.

9. The apparatus of claim 2, wherein the first container comprises a shut off valve that, when in a closed position, allows filtered fluid to accumulate within the container and, when in an open position, allows filtered fluid to exit the container, thereby producing second fluid flow by gravity.

10. The apparatus of claim 8, wherein the shut off valve is manually activated.

11. The apparatus of claim 8, wherein the shut off valve is electrically activated.

12. The apparatus of claim 11, further comprising:
a controller configured to provide a way to activate and deactivate the shut off valve that is electrically activated, in either an open and closed position, wherein such activation and deactivation is in response to an electrical impulse received from first container level sensor, and wherein such activation and deactivation allows filtered fluid to accumulate within first container, when such activation and deactivation produces shut off valve in the closed position, and otherwise allows the filtered fluid to exit first container when such activation or deactivation produces shut off valve that is in the open position.

13. The apparatus of claim 12, wherein tubing interposed between the plurality of separate containers provides a vent for air contained in interconnections to prevent interference with flow of fluid therein contained.

14. The apparatus of claim 2, wherein the second fluid driver comprises a gravity driven arrangement.

15. The apparatus of claim 2, wherein the second fluid driver comprises a non-gravity pressurizer attached to the first container, which is configured to pressurize the fluid contained in the first container.

16. The apparatus of claim 2, wherein the splitter comprises a dividing fitting interposed which is configured to divide second filtered water flow into a plurality of second filtered water flows, and where gravity induced flow produces combined water flow where dilution does not change as a result of change of height of filtered water accumulated in first container.

17. The apparatus of claim 16, further comprising:
a controller configured to receive an impulse from a sensor in proportion to height of filtered fluid in the first container and to activate or deactivate the electrically activated pump to produce a water system wherein activation is automatic.

18. The apparatus of claim 2, wherein the first container comprises a float valve which, when in open position, allows filtered fluid to flow to the first container, and which, when in closed position, prevents filtered fluid from flowing into the first container.

19. The apparatus of claim 2, further comprising:
a level sensor configured to measure water height within the first container, and also configured to produce an electrical impulse in proportion to a height of water therein contained.

20. The apparatus of claim 2, wherein the first conveyance comprises a three way connector interposed therein, and the second conveyance comprises a shut off valve, wherein the first conveyance and the second conveyance provide a filter backwash when pump operated in a reverse direction, in which filtered water flows through filter in the reverse direction and dislodges filtered matter accumulated within a filter cartridge, and discards such matter along the second conveyance.

21. The apparatus of claim 2, wherein the second container comprises a plurality of separate containers with interconnections and in which gravity induces flow of combined fluid to the output port containing a valve for output flow of combined fluid

22. The apparatus of claim 21, wherein the apparatus is configured to provide a maximum contact time for flow of combined water, wherein the combined water is configured to flow into the second container or plurality of separate containers and to flow entirely through the second container or multiple of separate containers, and thereafter through tubing to a valve.

23. The apparatus of claim 2, further comprising:
a float valve attached to the second container, wherein the float valve is configured to permit combined water to flow into the second container when the float valve is disposed in an open position, and is configured to prevent combined water from flowing into the second container when the float valve is disposed in a closed position.

24. A method, comprising:
receiving, at a first fluid input, first fluid;
inducing first fluid flow from the first fluid input through a first conveyance, a connector attaching the first conveyance to the first fluid input, and a second conveyance that conveys the first fluid to a filter;
rendering the first fluid as a first filtered fluid by the filter;
conveying the first filtered fluid to a first container;
inducing a second filtered fluid flow along a third conveyance that conveys the second filtered fluid from the first container;
dividing the second filtered fluid flow into a third filtered fluid flow and a fourth filtered fluid flow;
conveying the third filtered fluid flow to activate a second fluid input, wherein the second fluid input comprises a dispenser and subsequently to a second container;
conveying second fluid from the dispenser in response to being activated by the third filtered fluid flow;
combining the second fluid with the second filtered fluid to provide a combined fluid;
conveying the combined fluid to flow into the second container; and
inducing flow of combined fluid contained in the second container to an output port with a valve attached thereto, wherein the valve is configured to provide output flow for the combined fluid, wherein the combined fluid is potable.
